(19) United States
(12) Patent Application Publication
(10) Pub. No.: US 2026/0221077 A1
(43) Pub. Date: Jul. 30, 2026

(54) DRIVING MODULE FOR DISPLAY AND DISPLAY APPARATUS

(71) Applicants: Hefei BOE Vision-Electronic Technology Co., Ltd., Hefei, Anhui (CN); BOE Technology Group Co., Ltd., Beijing (CN)

(72) Inventors: Guozhao ZUO, Beijing (CN); Shenzhou NI, Beijing (CN); Chuguang QUE, Beijing (CN); Kai HE, Beijing (CN)

(21) Appl. No.: 19/148,733

(22) PCT Filed: Sep. 27, 2023
(86) PCT No.: PCT/CN2023/121961

§ 371 Date: Jul. 17, 2025

(51) Int. Cl. G09G 3/20

(52) U.S. Cl. CPC G09G 3/2096; G09G 2330/021; G09G 2330/04

(57) ABSTRACT

A driving module for display and a display apparatus. The driving module includes: a composite board configured to process various low-power signals; a mainboard configured to process digital multimedia signals, the digital multimedia signals including video format signals and the low-power signals; and a driving board separately connected to the mainboard and the composite board, the driving board being used for forwarding the video format signals to source driving boards, forwarding the various low power signals to the composite board, and performing power supply management and gamma voltage conversion.

### CROSS-REFERENCE TO RELATED APPLICATIONS

The disclosure is a national phase entry under 35 U.S.C. § 371 of International Application No. PCT/CN2023/121961, filed on Sep. 27, 2023, the entire content of which is incorporated herein by reference.

### TECHNICAL FIELD

The present disclosure relates to the field of display technology, in particular to a driving module for display and a display apparatus.

### BACKGROUND

In the design architecture of large-sized liquid crystal televisions, the functional boards are basically designed in a separated manner.

For example, a main board (MB), a power Board (P-Board), a Key Board (Key), a mobile hotspot (Wifi) Board, an audio (Microphone, MIC) Board, a timing controller (T-CON) Board and the like generally adopt a separated design and are connected by flexible flat cables (FFCs) or electronic wires. Moreover, different brand manufacturers have inconsistent layout requirements and external interfaces for each functional board, resulting in a large number of connecting wires, a complex assembly process, and long wire routing paths.

### SUMMARY

The embodiments of the present disclosure provide a driving module for display and a display apparatus, for solving the above technical problems existing in the prior art.

In a first aspect, in order to solve the above technical problems, the embodiments of the present disclosure provide a driving module for display, including: a composite board, configured to process a plurality of low-power signals; a main board, configured to process digital multimedia signals; where the digital multimedia signals include a video format signal and the plurality of low-power signals; and a driver board, connected to the main board and the composite board respectively; where the driver board is configured to forward the video format signal to a source driver board, forward the plurality of low-power signals to the composite board, and perform power management and gamma voltage conversion.

In a possible implementation mode, the driver board includes: a first interface, electrically connected to the main board; two speaker interfaces, electrically connected to two speakers respectively; two second interfaces, electrically connected to two source driver boards respectively; a third interface, disposed between the two second interfaces, and electrically connected to the composite board; a power management module, configured to convert an input first power supply to a second power supply required by the source driver board; and a clock management module, configured to convert an input first clock signal to a series of second clock signals required by the source driver board and provide the series of second clock signals to the source driver board.

In a possible implementation mode, the driver board further includes: a fourth interface electrically connected to an external communication board. The external communication board is configured to implement a function compatible with at least one of wifi or external Bluetooth.

In a possible implementation mode, the driving module further includes: a first flexible flat cable connected between the main board and the driver board; a second flexible flat cable, connected between the source driver board and the driver board; and a third flexible flat cable, connected between the composite board and the driver board.

In a possible implementation mode, the first flexible flat cable includes: a plurality of connection lines; and two connector interfaces connected to two ends of each of the plurality of connection lines respectively. Pin definitions are in reverse order between the two connector interfaces.

In a possible implementation mode, the connector interface includes a first group of pins, a second group of pins, a third group of pins and a fourth group of pins which are sequentially arranged; the first group of pins are configured to transmit the video format signal; the second group of pins are configured to transmit a power supply signal, and the power supply signal includes a plurality of voltage sources; the third group of pins are configured to transmit the low-power signals; floating pins are provided between the second group of pins and each of the first group of pins and the third group of pins; the fourth group of pins are configured to transmit high-power analogue signals; and two isolated ground pins are provided between the fourth group of pins and the third group of pins.

In a possible implementation mode, the second group of pins include: a first power supply pin, a second power supply pin, a third power supply pin and a fourth power supply pin arranged in sequence along a direction from the first group of pins to the third group of pins. The first power supply pin is configured to transmit a first power supply, and the first power supply pin includes a first quantity of pins. The second power supply pin is configured to transmit a second power supply, and the second power supply pin includes a second quantity of pins. A floating pin is provided between the first power supply pin and the second power supply pin, and the first quantity is greater than the second quantity. The third power supply pin and the fourth power supply pin correspond to different third power supplies respectively. A voltage of the first power supply, a voltage of the second power supply and a voltage of the third power supply are reduced in sequence.

In a possible implementation mode, the third group of pins include: a first subgroup of pins, configured to transmit enable and reset control signals for network communication; a second subgroup of pins, configured to transmit a universal serial bus signal; a third subgroup of pins, configured to transmit a data signal and a clock signal of a digital audio; and a fourth subgroup of pins, configured to transmit a key signal, an indicator signal, and an infrared signal. The fourth subgroup of pins are closer to the fourth group of pins than the first subgroup of pins, the second subgroup of pins and third subgroup of pins.

In a possible implementation mode, pins corresponding to the universal serial bus signal are designed with length-matched differential pairs with 90Ω controlled impedance.

In a possible implementation mode, both sides of pins corresponding to the clock signal of the digital audio and both sides of pins corresponding to the data signal of the digital audio are provided with signal grounds.

In a possible implementation mode, at least one isolated ground pin is provided between signal pins corresponding to every two signals of the high-power analogue signals; and the signal pin corresponding to each of the high-power analogue signals includes two pins.

In a possible implementation mode, two isolated ground pins are provided between two signal pins having the same current direction; and one isolated ground pin is provided between two signal pins with different current directions.

In a possible implementation mode, pins with strong anti-interference ability in the fourth subgroup of pins are closer to the fourth group of pins than the first subgroup of pins, the second subgroup of pins and third subgroup of pins.

In a possible implementation mode, the pins with strong anti-interference ability include pins corresponding to a key signal and an indicator signal.

In a possible implementation mode, in the connector interface, a pin of a signal ground is connected to the signal ground, and a pin of an isolated ground is electrically connected to the signal ground via a magnetic bead and a ground resistance.

In a possible implementation mode, the plurality of connection lines include: a first group of connection lines, connected to the first group of pins, the second group of pins and the third group of pins; and a second group of connection lines, connected to the fourth group of pins. The first flexible flat cable further includes a double-layer metallic shielding layer, covering two flat faces of the first group of connection lines and connected to ground.

In a possible implementation mode, the first flexible flat cable includes a plurality of merged lines, and a width of the merged line is greater than a total width of two adjacent connection lines. The merged line is configured to connect a wire transmitting the same signal through a plurality of pins.

In a possible implementation mode, at least one merged line is connected to a first power supply pin. The total width of the at least one merged line is equal to the total width of the first number of connection lines arranged in sequence.

In a possible implementation mode, the driving module further includes a power supply board and a power supply electronic line. The power supply electronic line is connected between the power supply board and the main board, and the power supply board is configured to supply power to the main board and receive a control signal from the main board for the power supply board.

In a second aspect, the embodiments of the disclosure provide a display apparatus, including: a display module, including at least one source driving circuit; and the driving module as described in the first aspect. The driving module is electrically connected to the source driving circuit.

### BRIEF DESCRIPTION OF FIGURES

FIG. 1 is a schematic diagram of a structure of a display apparatus in the related art.

FIG. 2 is a schematic diagram of a structure of a driving module according to embodiments of the present disclosure.

FIG. 3 is a schematic diagram of a structure of a driver board according to embodiments of the present disclosure.

FIG. 4 is another schematic diagram of a structure of a driving module according to embodiments of the present disclosure.

FIG. 5 is another schematic diagram of a structure of a driving module according to embodiments of the present disclosure.

FIG. 6 is another schematic diagram of a structure of a driving module according to embodiments of the present disclosure.

FIG. 7 is a schematic diagram of a structure of a first flexible flat cable according to embodiments of the present disclosure.

FIG. 8 is a schematic diagram of the connection of a fourth group of pins in a first flexible flat cable according to embodiments of the present disclosure.

FIG. 9 is a schematic diagram of two parallel conductors according to embodiments of the present disclosure.

FIG. 10 is a schematic diagram of a connector interface according to embodiments of the present disclosure.

FIG. 11 is a schematic diagram of a structure of a first flexible flat cable according to embodiments of the present disclosure.

FIG. 12 is another schematic diagram of a structure of a first flexible flat cable according to embodiments of the present disclosure.

FIG. 13 is another schematic diagram of a structure of a driving module according to embodiments of the present disclosure.

Reference numerals of drawings: composite board 1, main board 2, driver board 3, first interface 31, speaker interface 32, second interface 33, third interface 34, power management module 35, clock management module 36, fourth interface 37, first flexible flat cable 4, second flexible flat cable 5, third flexible flat cable 6, connection line 41, connector interface 42, first group of connection lines 41a, second group of connection lines 41b, double-layer metallic shielding layer 43, power supply board 7, power supply electronic line 8.

### DETAILED DESCRIPTION

Embodiments of the present disclosure provide a driving module for display and a display apparatus, to solve the above technical problems existing in the prior art.

In order to make the above objects, features and advantages of the present disclosure more apparent and understandable, the present disclosure will be further described hereinafter in conjunction with the accompanying drawings and embodiments. However, the exemplary embodiments are capable of being implemented in a variety of forms and should not be construed as being limited to the embodiments set forth herein; rather, these embodiments are provided so that the present disclosure is more comprehensive and complete, and the concept of the exemplary embodiments can be fully conveyed to those skilled in the art. In the drawings, the same reference numeral denotes the same or similar structures, and thus their repeated descriptions will be omitted. The words expressing positions and directions described in the present disclosure are all illustrated by taking the drawings as examples, but they can be changed as required, and all the changes made are included within the protection scope of the present disclosure. The drawings of the present disclosure are only for indicating the relative positional relationship and do not represent the true scale.

It should be noted that specific details are set forth in the following description to facilitate a full understanding of the present disclosure. However, the present disclosure is capable of being implemented in a variety of other ways different from those described herein, and those skilled in the art may make similar extensions without departing from the essence of the present disclosure. Thus the present disclosure is not limited by the specific implementation manners disclosed below. The subsequent description of the specification is preferred implementation manners of the present disclosure, but the description is for the purpose of illustrating the general principles of the present disclosure and is not intended to limit the scope of the present disclosure. The scope of protection of the present disclosure shall be as defined in the appended claims.

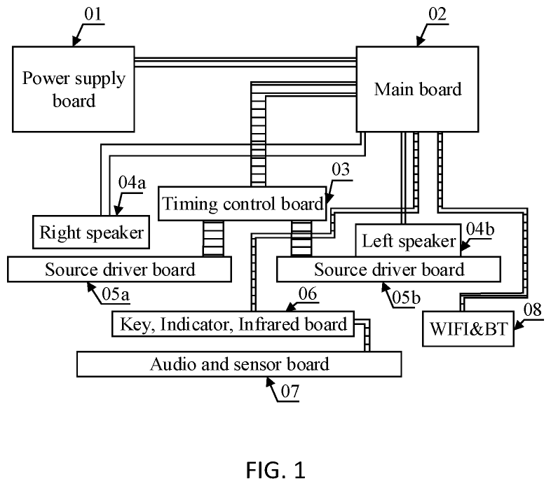

Referring to FIG. 1, it's a schematic diagram of a structure of a display apparatus in the related art.

The display apparatus includes a power supply board 01, a main board 02, a timing control board 03, a right speaker 04a, a left speaker 04b, a source driver board 05a, a source driver board 05b, a key+indicator+infrared board 06, an audio and sensor board 07, and a wireless network and Bluetooth (Wireless Fidelity & BlueTooth (WIFI&BT)) 08. In the related technology, the above functional boards in the display apparatus generally adopt a separate design and are connected through FFCs or electronic wires. Since the layout requirements and external interfaces of the functional boards for different brand manufacturers are not consistent, the number of connecting wires is large, the assembly process is complicated, and routing paths of the wires are long.

In addition, the main board 02 is generally fixed on a side of the inside of the display apparatus, rather than in the center. Other functional boards are controlled through the main board 02. However, the distances from the main board 02 to the other functional boards are far away, resulting in an increase in the length of the wires, as well as an increase in the number of fixed wire buckles, acetate tapes and so on. The interior of the whole machine is cluttered and affects aesthetics.

In order to solve the above problems, embodiments of the present disclosure provide a driving module for display and a display apparatus, which are described below in conjunction with the drawings.

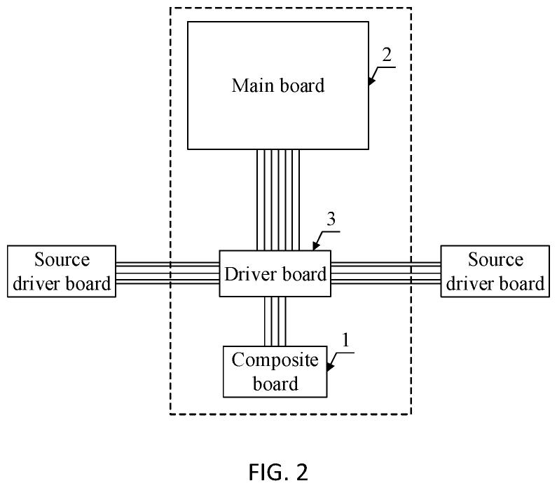

Please refer to FIG. 2, it's a schematic diagram of the structure of a driving module according to embodiments of the present disclosure. The driving module includes: a composite board 1, a main board 2, and a driver board 3.

The composite board 1 is configured to process a plurality of low-power signals. The composite board 1 may include a key function, a WIFI function, a Bluetooth function, an infrared function, an indicator function, and the like. The corresponding low-power signals may be a key signal, a WIFI/Bluetooth/infrared data signal, a control signal, an audio signal, an indicator signal, and the like. The composite board 1 may also not contain the WIFI function and Bluetooth function, i.e., the composite board 1 contains the key function, the infrared function, the indicator function and the like.

The main board 2 is configured to process digital multimedia signals; and the digital multimedia signals include a clock embedded differential signal (CEDS, also known as: a video format signal) and the low-power signals.

The driver board 3 is connected to the main board 2 and the composite board 1, respectively; and the driver board 3 is configured to forward the video format signal to a source driver board, forward the plurality of low-power signals to the composite board 1, and perform power management and gamma voltage conversion.

In the embodiments provided in the present disclosure, the composite board 1 is connected to the driver board 3, allowing the driver board 3 to forward the CEDS to the source driver board, forward the plurality of low-power signals to the composite board 1 and perform power management and gamma voltage conversion, so that the main board 2 is connected to the driver board 3 and is not connected to the composite board 1. Compared with the relevant technology in which the main board 2 is required to be connected to a variety of functional boards, this effectively reduces cables connected to the main board 2, and reduces and shortens wires, thereby reducing the auxiliary materials of the wires, reducing the production cost, improving the assembly efficiency, and beautifying the interior craftsmanship of the whole machine, and enhancing the competitiveness of the products.

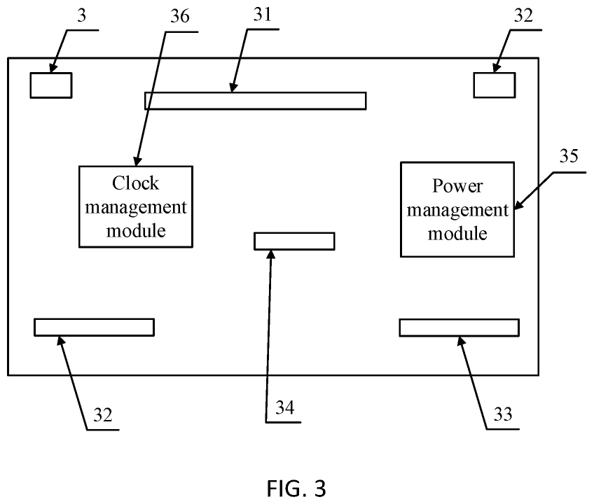

Please refer to FIG. 3 which is a schematic diagram of a structure of a driver board according to embodiments of the present disclosure, the driver board 3 includes: a first interface 31, two speaker interfaces 32, two second interfaces 33, a third interface 34, a power management module 35, and a clock management module 36.

The first interface 31 is electrically connected to the main board 2. The first interface 31 may be a standard interface having 96 pins (which may be noted as 96 pin), and correspondingly an interface corresponding to the first interface 31 is provided on the main board 2. The driver board 3 can be connected to the main board 2 through a 96-core cable to receive the multimedia signals processed by the main board 2.

The two speaker interfaces 32 are electrically connected to two speakers, respectively. The speaker interface 32 has two pins, which are connected to positive and negative poles of the speaker. Usually, a 12V analogue signal is connected to the speaker interfaces 32.

The two second interfaces 33 are electrically connected to the source driver boards. The second interface 33 may be an interface having 60 pins, usually the display module has two source driver boards, and thus the two second interfaces 33 of the driver board 3 are electrically connected to the two source driver boards respectively.

The third interface 34 is located between two second interfaces 33, and the third interface 34 is electrically connected to the composite board 1. When the composite board 1 contains a key function, a WIFI function, a Bluetooth function, an infrared function, an indicator function and so on, a fourth interface 37 may be an interface having 30 pins. When the composite board 1 contains a key function, an infrared function, an indicator function and so on (i.e., it does not contain a WIFI function or a Bluetooth function), the third interface 34 may be an interface having 14 pins.

Since the third interface 34 is disposed between the two second interfaces 33, the third interface 34 is at the closest distance from a key box, so that a length of a cable connecting the third interface 34 to the key box can be shortened, and there can be no crossover with other cables, so as to facilitate the assembly, and to eliminate the auxiliary materials of copper foil and acetate adhesive tape.

The power management module 35 is configured to convert an input first power supply to a second power supply required by the source driver board. The first power supply provides a 12V voltage; and the second power supply provides a voltage required for a high level (VGH) of the line drive of the display module, a voltage required for a low level (VGL) of the line drive of the display module, a power supply voltage (AVDD) of a digital-to-analog converter of the display module, a voltage (HAVDD) for the digital-to-analog converter of the display module in a low power state, a chip power supply voltage (VCC), a gamma voltage, a synchronization signal, and the like.

The clock management module 36 is configured to convert an input first clock signal into a series of second clock signals required by the source driver board, and provide the series of second clock signals to the source driver board. The first clock signal may be a clock signal generated by a crystal oscillator, and the second clock signal may be a signal obtained by amplifying the amplitude of the driving voltage for a series of clock signals required by the source driver board.

In the embodiments provided in the present disclosure, by providing in the driver board 3 a first interface 31 electrically connected to the main board 2, two speaker interfaces 32 electrically connected to two speakers, a second interface 33 electrically connected to the source driver board and a third interface 34 electrically connected to the composite board 1, the processed multimedia signals from the main board 2 can be received through the first interface 31, the CEDS signal in the processed multimedia signals are forwarded to the source driver board through the second interface 33, the low-power signals corresponding to the composite board 1 are forwarded to the composite board 1 through the third interface 34, at the same time, the input first power supply is converted into the second power supply required by the source driver board through the power management module 35, and the input first clock signal is converted into a series of second clock signals required by the source driver board and the series of second clock signals are provided to the source driver board through the clock management module 36. Since the above various functional boards are connected to the driver board 3, and the driver board 3 is relatively closer to the functional boards than the main board 2, it is possible to effectively reduce the number of cables connected to the main board 2, shorten a length of the cables used by each functional board, and make the cable layout more aesthetically pleasing.

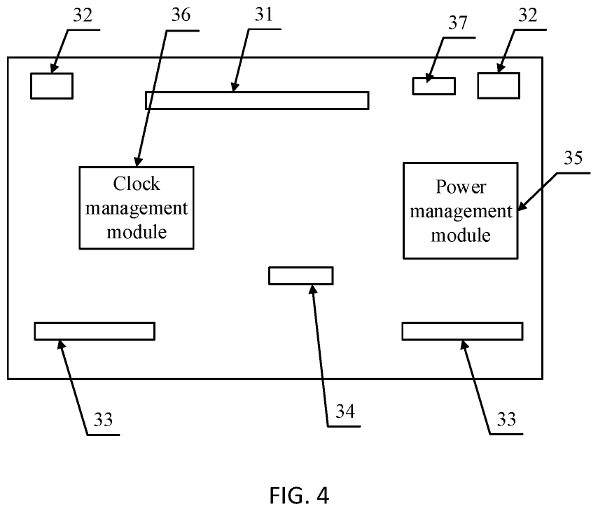

Referring to FIG. 4 which is another schematic diagram of the structure of the driving module according to embodiments of the present disclosure, the driver board 3 further includes:
a fourth interface 37 electrically connected to the external communication board, where the external communication board is configured to implement a function compatible with at least one of wifi or external Bluetooth. Usually, the external communication board and the composite board 1 implement different functions; for example, when the composite board 1 does not contain wifi and Bluetooth functions, the external communication board is compatible with wifi and external Bluetooth (compatible with the previous generation products). The fourth interface 37 may be a socket with 12 pins. The corresponding cable connected to the fourth interface 37 is a flat cable containing 12 cores.

In the embodiments provided in the present disclosure, by designing an external communication board compatible with wifi and Bluetooth of the previous generation products in the driver board 3, the compatibility of the products can be improved to meet different customer design requirements.

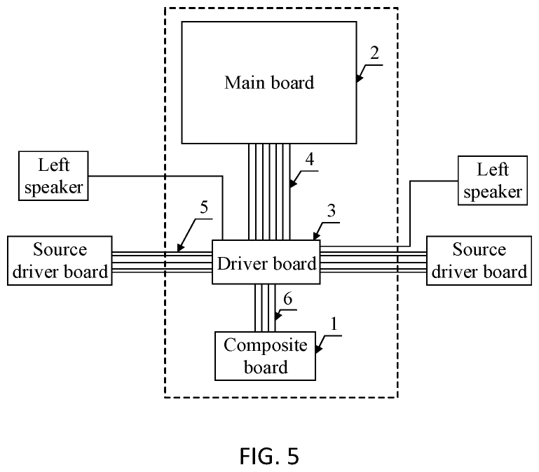

Referring to FIG. 5 which is another schematic diagram of the structure of the driving module according to embodiments of the present disclosure, the driving module further includes:
a first flexible flat cable 4, connected between the main board 2 and the driver board 3; herein, when the first interface 31 has 96 pins, the corresponding first flexible flat cable 4 also has 96 pins;
a second flexible flat cable 5, connected between the source driver board and the driver board 3; herein, when the third interface 34 has 60 pins, the corresponding second flexible flat cable 5 also has 60 pins; and
a third flexible flat cable 6, connected between the composite board 1 and the driver board 3; herein, when the fourth interface 37 has 30 pins, the corresponding third flexible flat cable 6 also has 30 pins.

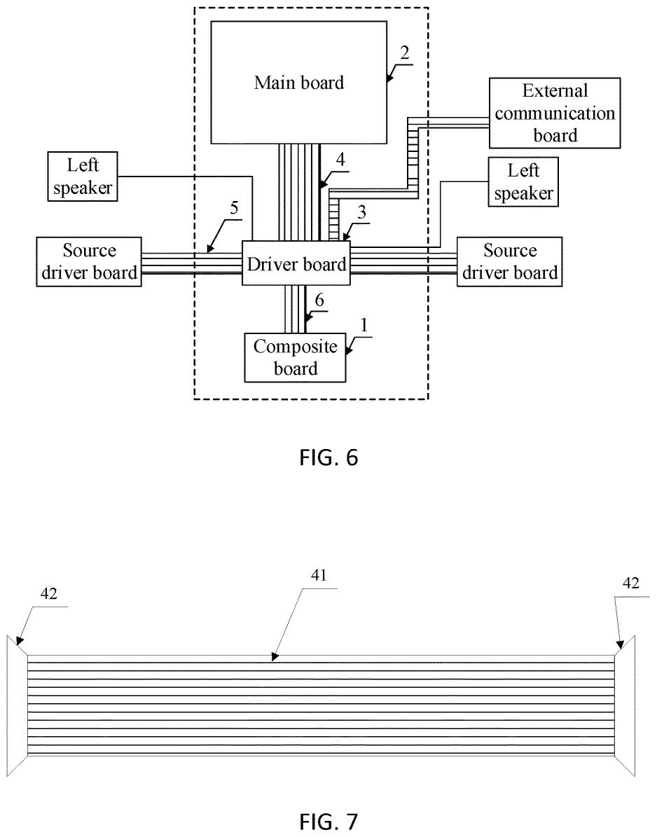

When the composite board 1 does not contain the wifi function and the Bluetooth function, i.e., when the driver board contains the fourth interface 37, as shown in FIG. 6 which is another schematic diagram of the structure of the driving module according to the embodiments of the present disclosure, the cable of the external communication board may be a 14-pin cable, and 2-core cables are used for connecting the left speaker and the right speaker. It may be possible that positive and negative poles of each speaker are connected to a connection line 41 respectively.

In the embodiments provided in the present disclosure, the driver board 3 is connected to the functional boards with flexible flat cables, to facilitate the assembly operation, thus effectively improving the production efficiency.

Please refer to FIG. 7 which is a schematic diagram of a structure of a first flexible flat cable according to embodiments of the present disclosure, the first flexible flat cable 4 includes:
a plurality of connection lines 41, and two connector interfaces 42 connected to two ends of each of the plurality of connection lines 41 respectively; where a definition order of pins in the two connector interfaces 42 is opposite.

As described above, the connector interface 42 includes 96 pins, and each pin has a corresponding pin number, noted as 1^{~}96. One of the connector interfaces 42 is defined sequentially from pin 1 to pin 96, and the other connector interface 42 is defined identically from pin 96 to pin 1.

In the embodiments provided in the present disclosure, the assembly errors can be prevented by providing connector interfaces 42 at both ends of the plurality of connection lines 41 with pins defined in a reverse order.

In some embodiments, the connector interface 42 includes a first group of pins, a second group of pins, a third group of pins and a fourth group of pins which are sequentially arranged;
the first group of pins are configured to transmit the video format signal;
the second group of pins are configured to transmit a power supply signal, and the power supply signal includes a plurality of voltage sources;
the third group of pins are configured to transmit the low-power signals; where floating pins are provided between the second group of pins and each of the first group of pins and the third group of pins; and
the fourth group of pins are configured to transmit a high-power analogue signal; where two isolated ground pins are provided between the fourth group of pins and the third group of pins.

Refer to Table 1, it is a pin definition table of a connector interface 42 according to embodiments of the present disclosure.

TABLE 1

| Pin | | |
|---|---|---|
| number | Definition | Group |
| 1-2 | SPK L+ (Left Speaker+) | Fourth group of pins |
| 3 | PGND (Isolated ground) | |
| 4-5 | SPK L− (left speaker−) | |
| 6-7 | PGND (Isolated ground) | |
| 8-9 | SPK R− (right speaker−) | |
| 10 | PGND (Isolated ground) | |
| 11-12 | SPK R+ (right speaker+) | |
| 13-14 | PGND (Isolated ground) | |
| 15 | LED EN (Indicator enable) | Third group of pins |
| 16 | KEY (Key) | (Note: Voice capture |
| 17 | GND (Signal ground) | is compatible with |
| 18 | IR IN (Infrared input) | I2S and PDM |
| 19 | GND | formats; |
| 20 | PDM DATA1 (Pulse density modulation | For analogue mic, |
| | data 1) | and I2S format, use |
| 21 | PDM DATA2 (Pulse density modulation | four wires |
| | data 2) | corresponding to |
| 22 | GND | Pin21/22/23/24 for |
| 23 | PDM CLK/BCLK (Pulse density | data clock signal; |
| | modulation clock) | For digital mic, and |
| 24 | I2S CLK (Compatible with built-in audio | PDM format, use |
| | bus clock) | three wires |
| 25 | GND | corresponding to |
| 26 | WIFI USB DN (USB format, differential | Pin21/22/23 for data |
| | signal 1) | clock signal;) |
| 27 | WIFI USB DP (USB format, differential | |
| | signal 2) | |
| 28 | GND | |
| 29 | PMU EN (Power management enable) | |
| 30 | WL WAKEUP AP (Wifi wake-up enable) | |
| 31 | BT WAKEUP AP (Bluetooth wake-up | |
| | enable) | |
| 32 | WIFI RST (Wifi reset) | |
| 33 | FLOAT | Float pin |
| 34 | STB 3.3 V (Standby power supply 3.3 V) | Second group of pins |
| 35 | VCC 3.3 V | |
| 36-37 | VCC 5 V | |
| 38 | FLOAT | |
| 39-44 | VDD IN (12 V Input) | |
| 45 | FLOAT | Float pin |
| 46 | C TEST WP (Read/Write Test) | First group of pins |
| 47 | SDA | |
| 48 | SCL | |
| 49 | GND | |
| 50-84 | CEDS Signal | |
| 85 | GND | |
| 86 | LOCK (Lock) | |
| 87 | SPI CS (Serial peripheral interface control) | |
| 88 | SPI DI (SPI Input) | |
| 89 | SPI DO (SPI Output) | |
| 90 | SPI SCK (SPI Clock) | |
| 91 | STV1 T (Clock start signal 1) | |
| 92 | CLK1 T (Clock 1) | |
| 93 | CLK2 T (Clock 2) | |
| 94 | LC (Liquid crystal polarity inversion | |
| | signal) | |
| 95 | STV0 (Start signal 0) | |

| | |
|---|---|
| 96 | Terminate (Clock reset signal) |

The above table indicates a pin definition of a connector interface 42 at one end of a flexible flat cable, and a definition of pins 96^{~}1 of the other connector interface 42 is the same as the definition of pins 1^{~}96 in the above table, which will not be repeated herein. In Table 1, the pin numbers of the first group of pins are 46^{~}96, the pin numbers of the second group of pins are 34^{~}44, the pin numbers of the third group of pins are 15^{~}32, and the pin numbers of the fourth group of pins are 1^{~}12.

In the embodiments provided in the present disclosure, by setting the pins of the connector interface 42 as a first group of pins for transmitting the CEDS signal, a second group of pins for transmitting voltage sources, a third group of pins for transmitting the low-power signals and a fourth group of pins for transmitting the high-power analogue signals, which are arranged in sequence and by setting two isolated grounds between the fourth group of pins and the third group of pins, it not only facilitates the transmission of the signals and but also reduces interference between different signals.

Please continue to refer to Table 1, the second group of pins include:
a first power supply pin (VDD IN), a second power supply pin (VCC 5V), a third power supply pin (VCC 3.3V), and a fourth power supply pin (STB 3.3V), which are sequentially arranged along a direction from the first group of pins to the third group of pins.

The first power supply pin is configured to transmit a first power supply, and the first power supply pin includes a first number of pins. The first number can be determined based on the current that the first power supply needs to provide and the current corresponding to a width of a single connection line 41 in the first flexible flat cable 4. For example, a designed through-current capacity of the first power supply (12V) is 4 A, the width of the single connection line 41 is 0.3, a gap between two adjacent connection lines 41 is 0.2, the single connection line 41 has a through-current capacity of 0.5 A (i.e., a width of 0.3 corresponds to a current of 0.5 A), and a width of 0.2 corresponds to a current of approximately 0.33 A. Here, the first power supply pin is actually composed of six pins corresponding to six connection lines 41. There may be three solutions when combining the corresponding connection lines 41.
Solution 1: six connection lines 41 are merged into one conductor, with a through-current capacity A=(6×0.5+5×0.33)≅4.65 A.
Solution 2: three connection lines 41 are merged into one conductor, and two conductors are used to be connected to the six pins. Two conductors have a total through-current capacity A=2×(3×0.5+2×0.33)≅4.32 A.
Solution 3: two connection lines 41 are merged into one conductor, and three conductors are used to be connected to the six pins. Three conductors have a total through-current capacity A=3×(2×0.5+0.33)≅3.99 A.

The first two solutions meet the design requirements, and solution 2 is preferred in terms of the cost and design margin.

The second power supply pin is configured to transmit a second power supply, and the second power supply pin includes a second number of pins. Herein, a floating pin is provided between the first power supply pin and the second power supply pin, and the first number is larger than the second number. The way to determine the second number is similar to that of the first number, and will not be repeated here. For example, the first number is determined as 2, that is, the second power supply pin consists of two pins.

The third power supply pin and the fourth power supply pin correspond to different third power supplies (3.3V), respectively. The voltages of the first power supply, the second power supply, and the third power supply are reduced in sequence.

In the embodiments provided in the present disclosure, by providing a floating pin between the first power supply and the second power supply, the high and low voltage sources can be isolated, to prevent the first flexible cable from being inserted out of alignment, so that a short circuit can be prevented and the circuit board can be avoided from being burned out, which can further effectively provide a generation yield and an after-sale yield. By arranging the second power supply pin to the fourth power supply pin adjacent to each other, the number of pins occupied by the voltage sources can be effectively saved.

Please continue to refer to Table 1, the third group of pins include:
a first subgroup of pins configured to transmit enable and reset control signals for network communication; herein, one floating pin is provided between the second group of pins and each of the first group of pins and the third group of pins;
a second subgroup of pins configured to transmit a universal serial bus signal;
a third subgroup of pins configured to transmit a data signal and a clock signal of a digital audio; and
a fourth subgroup of pins configured to transmit a key signal, an indicator signal, and an infrared signal; herein, the fourth subgroup of pins are close to the fourth group of pins.

In the embodiments provided in the present disclosure, the third group of pins transmit the low-power signals, and the fourth subgroup of pins for transmitting the key signal, the indicator signal and the infrared signal are more resistant to interference, so that the fourth subgroup of pins in the third group of pins that are more resistant to interference is set close to the fourth group of pins for transmitting the high-power analogue signals. This can effectively reduce the interference of the high-power analogue signals on the low-power signals, and improve the stability of the signal transmission of the first flexible flat cable 4.

In some embodiments, pins corresponding to the universal serial bus signal are designed with length-matched differential pairs with 90Ω controlled impedance, which can improve the anti-interference ability of the serial bus.

In some other embodiments, both sides of pins corresponding to the clock signal of the digital audio and both sides of pins corresponding to the data signal of the digital audio are provided with signal grounds, which can prevent the digital audio to interfere with the clock signal, and improve the anti-interference ability of the digital audio.

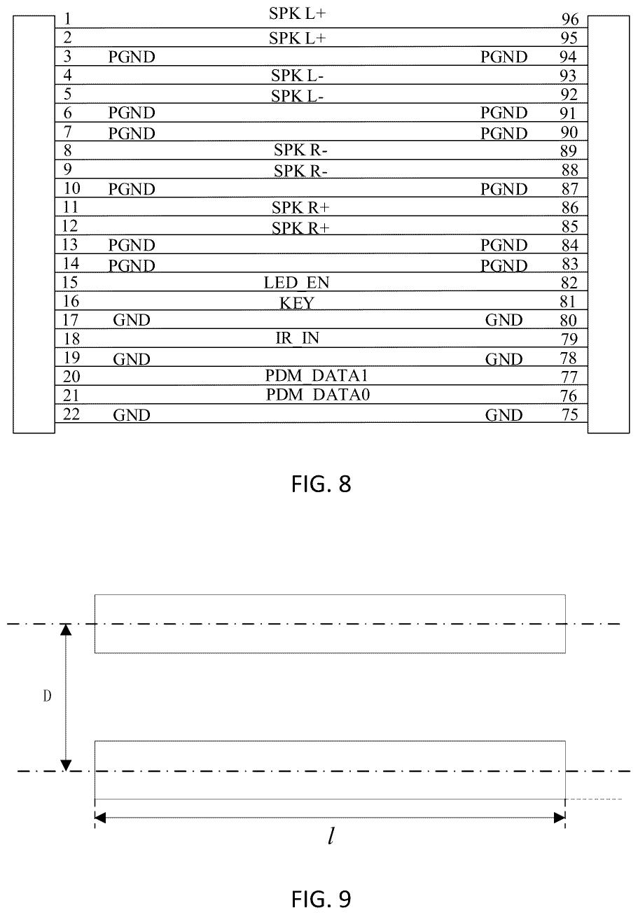

Refer to FIG. 8, it is a schematic diagram of the connection of the fourth group of pins in the first flexible flat cable according to the embodiments of the present disclosure. At least one isolated ground pin is provided between signal pins corresponding to every two signals in the high-power analogue signals; where the signal pin corresponding to each of the high-power analogue signals include two pins.

For example, in FIG. 8, SPK L+ is used for transmitting a positive signal of the left speaker, corresponding to two pins in each connector interface 42 (pin 1 and pin 2, and the opposite ends are pin 96 and pin 95), and the two pins are a signal pin in the fourth group of pins; SPK L− is used for transmitting a negative signal of the left speaker, corresponding to two pins in each connector interface 42 (pin 4 and pin 5, and the opposite ends are pins 93 and pin 92), and the two pins are also a signal pin in the fourth group of pins; and others are analogous, and will not be repeated here.

The high-power analogue signals usually need to be used when the left speaker and the right speaker are driven to play sounds. The high-power analogue signal is usually an alternating current signal with a sine wave output, and the current fluctuates in magnitude, which will lead to changes in the magnetic field in the surrounding region. Therefore, self-inductance and mutual inductance occur between two wires (usually parallel) that transmit positive and negative signals of the left speaker or the right speaker. In addition, due to the high power, the large current and the significant variation of the alternating current signals of the speakers, the signals adjacent to them are greatly affected by the mutual inductance of the two wires, and ultimately the signal quality will be disturbed.

Referring to FIG. 9, it is a schematic diagram of two parallel conductors according to embodiments of the present disclosure. The mutual inductance of the two parallel conductors is calculated as:

$$M = \frac{{μ}_{0} l}{2 π} ( ln \frac{2 I}{D} - 1 ) . \qquad ( H )$$

Herein, M is the mutual inductance, μ₀ is the vacuum permeability, l is a length of the parallel conductor, and D is a distance between centre lines of the two parallel conductors.

The formula for calculating the self-inductance of the two parallel conductors is:

$$L = ( \int B \cdot dS ) / I .$$

Herein, L is the self-inductance of the two parallel conductors, B is the magnetic flux between the two parallel conductors, S is a cross-sectional area of the parallel conductor, and I is the current on the parallel conductor.

Since the current directions of the two parallel conductors are different, correspondingly, the calculation methods of their effective inductances are different.

If the currents of the two parallel conductors are in the same direction, their effective inductance (denoted as N) is N=M+L.

If the currents of the two parallel conductors are in opposite directions, their effective inductance (denoted as N) is N=L−M.

As shown in FIG. 8, the left connector interface 42 corresponds to pins 4 and 5 that transmit the signal SPK_L−, pins 8 and 9 transmit the signal SPK_R−, SPK_L− and SPK_R− have the same current direction, and there will be an interference between the negative pole of the left channel (L−) and the negative pole of the right channel (R−). When mutual interference between the left (L) and right (R) channel signals occurs, crosstalk between the R channel the L channel will occur, and current spurious signal will be generated, which will lead to abnormal sound output from the speaker. The present disclosure adds two isolated ground (PGND) pins between the signal pins corresponding to SPK_L− and SPK_R− for isolation, which can increase a distance D=1.2 mm between the signal pins corresponding to SPK_L− and SPK_R−, and at the same time, reduce the influence of self-inductance and mutual inductance.

As another example, pins 4 and 5 transmit the signal SPK_L−, pins 1 and 2 transmit the signal SPK_L+, and SPK_L− and SPK_L+ have opposite current directions. Although the interference between the positive pole of the left channel (L+) and the negative pole of the left channel (L−) is weakened, there is still inductance. The present disclosure adds one isolated ground (PGND) pin between the signal pins corresponding to SPK_L− and SPK_L+ for isolation, which can increase a distance D=0.7 mm between the signal pins corresponding to SPK_L− and SPK_L+. At the same time, since the GND isolation, the influence of the self-inductance and mutual inductance is reduced.

As another example, the pins 11 and 12 transmit the signal SPK_R+, which is a high-power analogue signal, the current output follows a sine wave, and the current fluctuates in magnitude. Due to the continuous change of current, there will be a change in the magnetic field in the surrounding region. When pins corresponding to other low-power signals are too close to pins 11 and 12, after the influence of mutual inductance coupling, the quality of other low-power signals will not meet design requirements. The present disclosure can effectively reduce the influence of SPK_R+ on other low-power signals by adding 2-Pin PGND between pin 12 and the pins corresponding to other low-power signals.

In order to improve the interference, caused by the effective inductance generated during signal transmission of the wires corresponding to the left speaker and the right speaker, to the adjacent signals, the present disclosure provides at least one isolated ground pin between the signal pins corresponding to the signals in the power analogue signals. For example, two isolated ground pins are provided between two signal pins having the same current direction, and one isolated ground pin is provided between two signal pins having different current directions, so that the distance between adjacent signal pins can be increased, the effective inductance between adjacent signal pins can be reduced, and thus the interference to adjacent signal pins can be reduced, to improve the transmission quality of the high-power analogue signals. The two pins are used to constitute a signal pin in the high-power analogue signal, which can increase the through-current capacity of the signal pins corresponding to the high-power analogue signals, and prevent the pins from being damaged.

In some embodiments, a pin with strong anti-interference ability in the fourth subgroup of pins is close to the fourth group of pins.

As shown in FIG. 8, in the left connector interface 42, pin 15 transmits an enable signal of the indicator, and pin 16 transmits a signal of the key, which have strong anti-interference ability. The signal close to SPK_R+ can also be designed as an enable signal with strong anti-interference ability, and pins 15 and 16 corresponding to LED_EN/KEY can be close to pin 12.

The pins with strong anti-interference ability in the fourth subgroup of pins are close to the fourth group of pins, which can further reduce the influence of the pins transmitting the high-power analogue signals on other signals with weak anti-interference ability, and improve the stability of signal transmission.

In some embodiments, a signal ground may also be provided on both sides of the pin corresponding to the low-power signal, for example, GND is provided on both sides of the pin corresponding to the IR_IN (infrared) signal in FIG. 8, which improves the anti-interference ability of the low-power signals and improves the stability of the signal transmission.

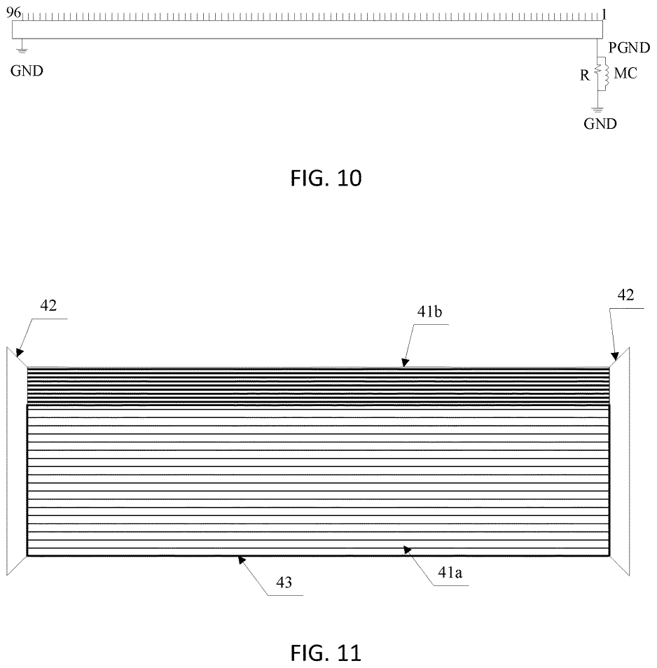

Referring to FIG. 10, it is a schematic diagram of a connector interface according to embodiments of the present disclosure.

In the connector interface 42, a pin of the signal ground is connected to the signal ground, and a pin of the isolated ground is electrically connected to the signal ground via a magnetic bead MC and a ground resistance R.

In the embodiments provided in the present disclosure, in the connector interface 42, the pin of the signal ground is connected to the signal ground, and the pin of the isolated ground is electrically connected to the signal ground via the magnetic bead MC and the ground resistance R, which can improve the anti-interference ability of the connector interface 42.

Referring to FIG. 11, it is a schematic diagram of a structure of a first flexible flat cable according to embodiments of the present disclosure. A plurality of connection lines 41 of the first flexible flat cable 4 include:
a first group of connection lines 41a, connected to a first group of pins, a second group of pins and a third group of pins; and
a second group of connection lines 41b, connected to a fourth group of pins.

The first flexible flat cable 4 further includes a double-layer metallic shielding layer 43, covering two flat faces of the first group of connection lines 41a and connected to ground.

In the embodiments provided in the present disclosure, the double-layer metallic shielding layer 43 covers the first group of connection lines 41a corresponding to the CEDS signals and the low-power signals, and the double-layer metallic shielding layer 43 is connected to ground, which can improve the anti-interference ability of the CEDS signals and the low-power signals, and improve the reliability of the signal transmission.

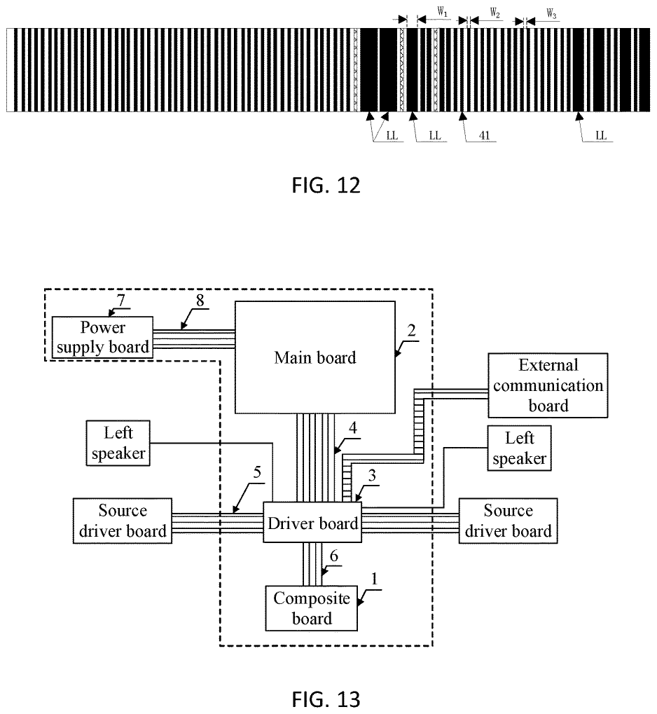

Please refer to FIG. 12, it is another schematic diagram of a structure of a first flexible flat cable according to embodiments of the present disclosure.

The first flexible flat cable 4 includes a plurality of merged lines LL, and a width w₁ of the merged line is a distance between outer edges of two connection lines that are the farthest apart among multiple adjacent connection lines 41 which are merged.

The merged line is configured to connect a wire transmitting the same signal by a plurality of pins.

For example, the merged line corresponding to the 5V power supply consists of two connection lines 41; and one connection line 41 has a width of w₂, corresponding to a through-current capacity of 0.5 A. A width of a gap between two connection lines 41 is w₃, and then the width w₁ of the merged line corresponding to the 5V is 2w₂+w₃.

The through-current capacity A of the merged line corresponding to the 5V power supply is A=[(2×w₂+w₃)/w₂]×0.5 A.

For example, the first power supply pin consists of six pins, and then the above solution 2 is preferable. Two merged lines with a width w₁ of 3w₂+2w₃, and a total through-current capacity A of the two merged lines corresponding to the first power supply is A=2×[(3×w₂+2×w₃)/w₂]×0.5 A.

By setting the width of the merged line corresponding to a plurality of pins that transmit the same signal as the distance between the outer edges of the two connection lines that are farthest apart among multiple adjacent connection lines 41 which are merged, the through-current capacity of the merged line can be increased, and the load carrying capacity and the stability of the signal can be improved.

In some embodiments, at least one merged line is connected to the first power supply pin.

Referring to FIG. 13 which is another schematic diagram of a structure of a driving module according to embodiments of the present disclosure, the driving module further includes: a power supply board 7 and a power supply electronic line 8. The power supply electronic line 8 is connected between the power supply board 7 and the main board 2, and the power supply board 7 is configured to supply power to the main board 2 and receive a control signal from the main board 2 for the power supply board 7.

Based on the same inventive concept, embodiments of the present disclosure provide a display apparatus, including:
a display module, including at least one source driving circuit; and
the driving module as described above, where the driving module is electrically connected to the source driving circuit.

The display apparatus can be a liquid crystal display (LCD), a liquid crystal display screen, a liquid crystal television or other display apparatuses. The display apparatus can also be a mobile phone, a tablet computer, a laptop or other mobile devices.

Although preferred embodiments of the present disclosure have been described, those skilled in the art may make additional changes and modifications to these embodiments once the basic inventive concepts are known. Therefore, the appended claims are intended to be construed to include the preferred embodiments as well as all changes and modifications that fall within the scope of the present disclosure.

Obviously, a person skilled in the art can make various modifications and variations to the present disclosure without departing from the spirit and scope of the present disclosure. Thus, if these modifications and variations of the present disclosure fall within the scope of the claims of the present disclosure and their technical equivalents, the present disclosure is intended to encompass these modifications and variations.

1. A driving module for display, comprising:
a composite board, configured to process a plurality of low-power signals;
a main board, configured to process digital multimedia signals; wherein the digital multimedia signals comprise a video format signal and the plurality of low-power signals; and
a driver board, connected to the main board and the composite board respectively; wherein the driver board is configured to forward the video format signal to a source driver board, forward the plurality of low-power signals to the composite board, and perform power management and gamma voltage conversion.

2. The driving module according to claim 1, wherein the driver board comprises:
a first interface, electrically connected to the main board;
two speaker interfaces, electrically connected to two speakers respectively;
two second interfaces, electrically connected to two source driver boards respectively;
a third interface, disposed between the two second interfaces, and electrically connected to the composite board;
a power management module, configured to convert an input first power supply to a second power supply required by the source driver board; and
a clock management module, configured to convert an input first clock signal to a series of second clock signals required by the source driver board and provide the series of second clock signals to the source driver board.

3. The driving module according to claim 2, wherein the driver board further comprises:
a fourth interface electrically connected to an external communication board, wherein the external communication board is configured to implement a function compatible with at least one of wifi or external Bluetooth.

4. The driving module according to claim 1, further comprising:
a first flexible flat cable connected between the main board and the driver board;
a second flexible flat cable, connected between the source driver board and the driver board; and
a third flexible flat cable, connected between the composite board and the driver board.

5. The driving module according to claim 4, wherein the first flexible flat cable comprises:
a plurality of connection lines; and
two connector interfaces connected to two ends of each of the plurality of connection lines respectively; wherein pin definitions are in reverse order between the two connector interfaces.

6. The driving module according to claim 5, wherein the connector interface comprises a first group of pins, a second group of pins, a third group of pins and a fourth group of pins which are sequentially arranged;
the first group of pins are configured to transmit the video format signal;
the second group of pins are configured to transmit a power supply signal, wherein the power supply signal comprises a plurality of voltage sources;
the third group of pins are configured to transmit the low-power signals; wherein floating pins are provided between the second group of pins and each of the first group of pins and the third group of pins;
the fourth group of pins are configured to transmit high-power analogue signals; wherein two isolated ground pins are provided between the fourth group of pins and the third group of pins.

7. The driving module according to claim 6, wherein the second group of pins comprise:
a first power supply pin, a second power supply pin, a third power supply pin and a fourth power supply pin arranged in sequence along a direction from the first group of pins to the third group of pins;
wherein the first power supply pin is configured to transmit a first power supply, and the first power supply pin comprises a first quantity of pins;
the second power supply pin is configured to transmit a second power supply, and the second power supply pin comprises a second quantity of pins; wherein a floating pin is provided between the first power supply pin and the second power supply pin, and the first quantity is greater than the second quantity;
the third power supply pin and the fourth power supply pin correspond to different third power supplies respectively; wherein a voltage of the first power supply, a voltage of the second power supply and a voltage of the third power supply are reduced in sequence.

8. The driving module according to claim 6, wherein the third group of pins comprise:
a first subgroup of pins, configured to transmit enable and reset control signals for network communication;
a second subgroup of pins, configured to transmit a universal serial bus signal;
a third subgroup of pins, configured to transmit a data signal and a clock signal of a digital audio; and
a fourth subgroup of pins, configured to transmit a key signal, an indicator signal, and an infrared signal; wherein the fourth subgroup of pins are closer to the fourth group of pins than the first subgroup of pins, the second subgroup of pins and third subgroup of pins.

9. The driving module according to claim 8, wherein pins corresponding to the universal serial bus signal are designed with length-matched differential pairs with 90Ω controlled impedance.

10. The driving module according to claim 8, wherein both sides of pins corresponding to the clock signal of the digital audio and both sides of pins corresponding to the data signal of the digital audio are provided with signal grounds.

11. The driving module according to claim 6, wherein at least one isolated ground pin is provided between signal pins corresponding to every two signals of the high-power analogue signals; wherein the signal pin corresponding to each of the high-power analogue signals comprises two pins.

12. The driving module according to claim 11, wherein two isolated ground pins are provided between two signal pins having the same current direction; and
one isolated ground pin is provided between two signal pins with different current directions.

13. The driving module according to claim 5, wherein pins with strong anti-interference ability in the fourth subgroup of pins are closer to the fourth group of pins than the first subgroup of pins, the second subgroup of pins and third subgroup of pins.

14. The driving module according to claim 13, wherein the pins with strong anti-interference ability comprise pins corresponding to a key signal and an indicator signal.

15. The driving module according to claim 6, wherein in the connector interface, a pin of a signal ground is connected to the signal ground, and a pin of an isolated ground is electrically connected to the signal ground via a magnetic bead and a ground resistance.

16. The driving module according to claim 6, wherein the plurality of connection lines comprise:
a first group of connection lines, connected to the first group of pins, the second group of pins and the third group of pins; and
a second group of connection lines, connected to the fourth group of pins;
wherein the first flexible flat cable further comprises a double-layer metallic shielding layer, covering two flat faces of the first group of connection lines and connected to ground.

17. The driving module according to claim 16, wherein the first flexible flat cable comprises a plurality of merged lines, and a width of the merged line is a distance between outer edges of two connection lines that are the farthest apart among multiple adjacent connection lines which are merged;
the merged line is configured to connect a wire transmitting the same signal through a plurality of pins.

18. The driving module according to claim 17, wherein at least one merged line is connected to a first power supply pin.

19. The driving module according to claim 1, further comprising:
a power supply board and a power supply electronic line;
wherein the power supply electronic line is connected between the power supply board and the main board, and the power supply board is configured to supply power to the main board and receive a control signal from the main board for the power supply board.

20. A display apparatus, comprising:
a display module, comprising at least one source driving circuit; and
the driving module according to claim 1; wherein the driving module is electrically connected to the source driving circuit.
